(19) United States
(12) Patent Application Publication
(10) Pub. No.: US 2013/0235432 A1
(43) Pub. Date: Sep. 12, 2013

(54) ERASURE DECISION DEVICE, IMAGE PROCESSING DEVICE, AND IMAGE FORMING DEVICE

(71) Applicant: TOSHIBA TEC KABUSHIKI KAISHA, Tokyo (JP)

(72) Inventor: Takeharu SHOKAI, Shizuoka (JP)

(73) Assignee: Toshiba Tec Kabushiki Kaisha, Tokyo (JP)

(21) Appl. No.: 13/786,398

(22) Filed: Mar. 5, 2013

Related U.S. Application Data
(60) Provisional application No. 61/608,606, filed on Mar. 8, 2012.

(51) Int. Cl. H04N 1/00

(52) U.S. Cl. CPC H04N 1/00074
USPC 358/3.28; 358/406; 358/1.12; 358/1.15

(57) ABSTRACT

According to embodiments, an erasure decision device is disclosed. The erasure decision device comprises a detection unit configured to detect at least one mark at a predetermined position on a sheet after an erasing treatment and to output the detection result. The erasure decision device further comprises a control unit configured to determine whether a residual image remains on the sheet after the erasing treatment based on the detection result.

### CROSS-REFERENCE TO RELATED APPLICATION

This application is based upon and claims the benefit of priority from U.S. provisional application 61/608, 606, filed on Mar. 8, 2012; the entire contents of which are incorporated herein by reference.

### FIELD

Embodiments described herein relate to a technique for determining whether or not an image on a sheet has been erased.

### BACKGROUND

Use has been made of an image forming device for forming an image on a sheet using a erasable toner at a fixed temperature; also use has been made of a device for erasing the toner image when the sheet is used.

In the sheet in which such an erasable toner is used, if the sheet is used several times, the image sometimes remains even if the erasing process is carried out. As the erasing device, there is also a device that decides the existence of the residual image, distributes reusable sheets and non-reusable sheets, and discharges the sheets. In deciding whether a residual image exists, in the conventional erasing device, for example, a scanner including an image pickup device such as a CCD sensor is mounted, an erased sheet is scanned, and whether or not the sheet has been fully erased is checked.

However, since the conventional erasing device is mounted with the scanner, the cost is raised.

### DESCRIPTION OF THE DRAWINGS

FIG. 1 shows an example of an image forming device, according to embodiments.

FIG. 2 shows an example of patches, which are printed by the image forming device, and an example of patch printing positions, according to an embodiment.

FIG. 3 shows an example of an erasing device, according to an embodiment.

FIG. 4 shows an example of a mechanism for a detection decision, according to an embodiment.

FIG. 5 shows an operation example of a sheet distribution decision after the printing of a sheet with patches and erasing an image, according to the embodiment.

### DETAILED DESCRIPTION

An erasure decision device according to an embodiment comprises a detection unit configured to detect at least one mark at a predetermined position on a sheet after an erasing treatment and to output the detection result. The erasure decision device further comprises a control unit configured to determine whether a residual image remains on the sheet after the erasing treatment based on the detection result.

An image processing device according to an embodiment comprises an erasure unit configured to erase images formed on a sheet, and a detection unit configured to detect at least one mark at a predetermined position on a sheet after an erasing treatment and to output the detection result. The image processing device further comprises a control unit configured to determine whether a residual image remains on the sheet after the erasing treatment based on the detection result.

An image forming device according to an embodiment comprises an image acquisition unit configured to acquire an image to be printed, and an image formation unit configured to form the image to be printed by an erasable colorant on a recording medium, and to form at least one mark by the erasable colorant at a predetermined area on the recording medium other than an area where the image is formed by the erasable colorant.

Next, aspects of the embodiments will be explained with reference to the figures.

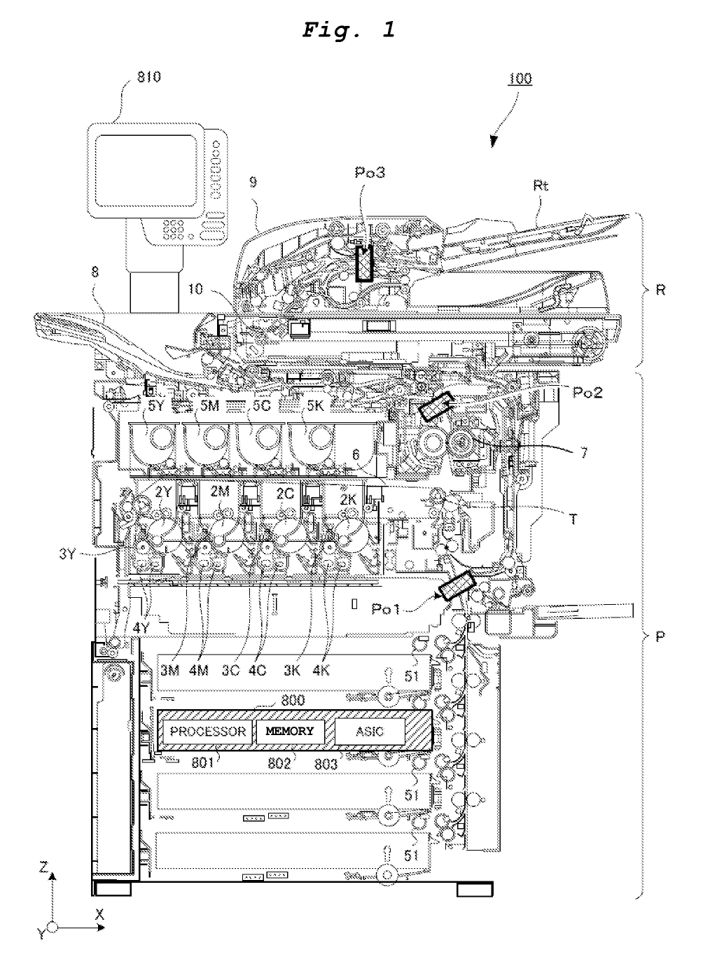

FIG. 1 is a vertical cross section showing an outlined constitution of the image forming device (MFP: Multi Function Peripheral) in this embodiment. As shown in FIG. 1, an image forming device 100 is provided with a read part R and an image formation part P.

The read part R has the function of reading images of a sheet original and a book original by scanning. The read part R is provided with a scanning optical system 10 including several reflection mirrors or image pickup devices and is also provided with an automatic document feeder 9 that can automatically convey an original up to a designated placing position. An image of the original which is automatically conveyed by the automatic document feeder 9, or the original which is placed on an original tray (not shown in the figure), is read out by the scanning optical system 10.

The image formation part P has the function of forming a developing agent image on a sheet based on the image read out of the original by the read part R or based on image data transmitted to the image forming device 100 from an external source. In addition, the image formation part P is provided with photosensitive bodies 2Y-2K, developing rollers 3Y-3K, mixers 4Y-4K, an intermediate transfer belt 6, a fixer 7, and a discharge tray 8.

Moreover, the image formation part P has toner cartridges 5Y-5K for housing erasable colorant. The erasable colorant includes a colorable compound, a developer, and a decolorant. As the colorable compound, for example, a leuco dye can be utilized. As the developer, for example, phenols can be utilized. As the decolorant, a substance that is compatible with the colorable compound when it is heated and that does not have an affinity for the developer can be utilized. The erasable colorant generates a color by the interaction of the colorable compound and the developer and is erased after the interaction of the colorable compound and the developer is stopped by heating at an erasing temperature or higher.

The image forming device 100 has a control unit 800 for overall control of each hardware component and/or software module in the device. The control unit 800 has a processor 801, a memory 802, and an Application Specific Integrated Circuit (ASIC) 803. The processor 801 includes, for example, an arithmetic operation unit such as a Central Processing Unit (CPU) and/or a Micro Processing Unit (MPU). The processor 801 has the role of implementing various kinds of processes in the image forming device 100 and realizes various functions by loading and implementing programs stored in advance in the memory 802.

The memory 802 is a storage unit including a Random Access Memory (RAM) as the main memory device and a nonvolatile memory device such as a flash memory and hard disk drive. The ASIC 803 is a unit for controlling data transmission and reception from an external appliance.

In addition, the image forming device 100 includes a control panel 810. The control panel 810 includes a touch panel for receiving instructions from a user and a display panel for displaying process contents or messages to the user. The touch panel can be integrated with the display as a touch screen display device for displaying an interface image to the user and accepting input from the user.

Next, as an example of processes in the image forming device of this embodiment, the outline of a copy process will be explained. First, a sheet picked up by pickup rollers 51 is fed into sheet conveyance paths. The sheets fed into the sheet conveyance paths are conveyed in a designated conveying direction by several roller pairs.

Next, images of several sheet originals, which are continuously and automatically conveyed by the automatic document feeder 9, are read out by the scanning optical system 10.

Next, the control unit 800 applies image processing to image data read out of the originals by the read part R. Electrostatic latent images of the data after the image processing are then formed on photosensitive surfaces of the photosensitive bodies 2Y, 2M, 2C, and 2K for transferring developing agent images of Y (yellow), M (magenta), C (cyan), and K (black) to the sheets.

Next, color-erasable toners, which are supplied from the toner cartridges 5Y-5K, are stirred by the mixers 4Y-4K in a developing processor. In addition, the erasable toners are supplied to photosensitive bodies 2Y-2K, on which the electrostatic latent images have been formed as utilized above, by developing rollers (so-called mag rollers) 3Y-3K. Thereby the electrostatic latent images formed on the photosensitive surfaces of the photosensitive bodies are developed.

The developing agent images formed on the photosensitive bodies in this manner are transferred (so-called primary transfer) onto a belt surface of the intermediate transfer belt 6 and the developing agent images, which are transferred by the rotation of the intermediate transfer belt, are transferred onto the sheets, which are conveyed, at a secondary transfer position T.

The developing agent images transferred onto the sheets are heated and fixed to the sheet by the fixer 7. The sheets to which the developing agent images have been heated and fixed are conveyed in the conveyance paths by several conveying rollers and sequentially discharged onto the discharge tray 8.

Here, Po1, Po2, and Po3 of FIG. 1 illustrate mounting positions of the case wherein detection parts (described later) are mounted in the image forming device. The image forming device 100 has already been explained with respect to forming images with colors and using toners of several colors, However, this image forming device may also be used for monochrome printing. In monochrome printing, to discriminate printed matter formed with erasable toners from printed matter using ordinary toners, printing with another color (for example, blue color) instead of black may be carried out.

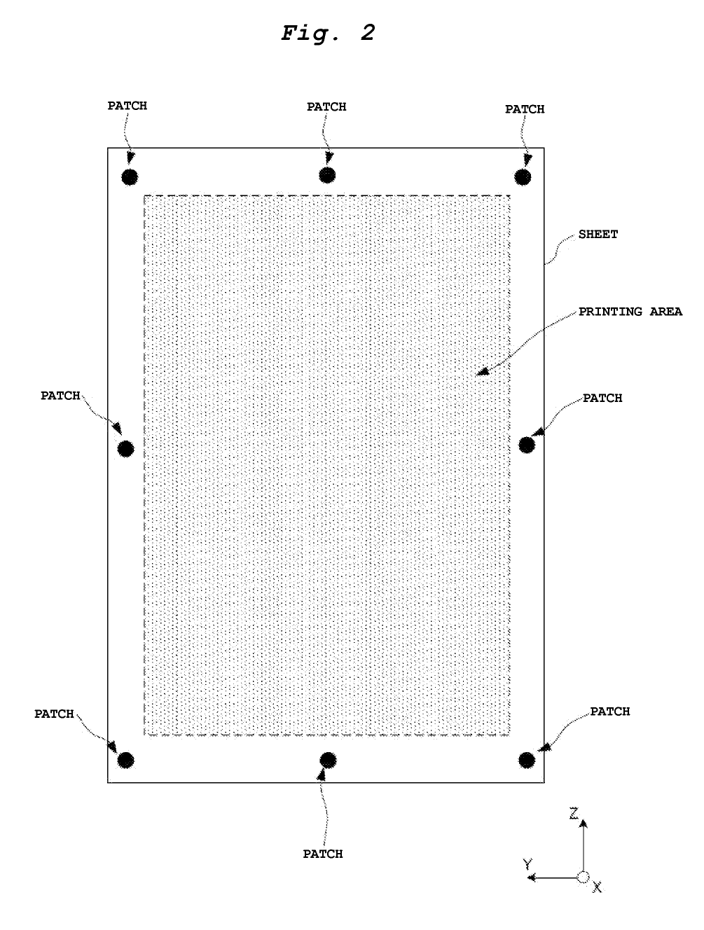

FIG. 2 shows an example of a sheet on which an image has been formed by the image forming device 100 and illustrates the shape of patches and positions where the patches are attached. The image formation part P renders circular patches to blank parts such as the header area and footer area by a erasable toner. FIG. 2 shows an example in which patches are given to 8 positions of at the left top, upper center, right top, right center, right bottom, lower center, left bottom, and left center. The patches may be given to one position or several positions. In addition, the positions of the patches are not limited to the example of FIG. 2. Areas other than the place (netted area of FIG. 2) where the desired image of a user is printed may be made use of for the one or more patches. The shape of the patches may be any type such as rectangular and the shape of a cross. Moreover, the positions or shape can be designated by the user. The patches are formed each time according to the designated positions and shape.

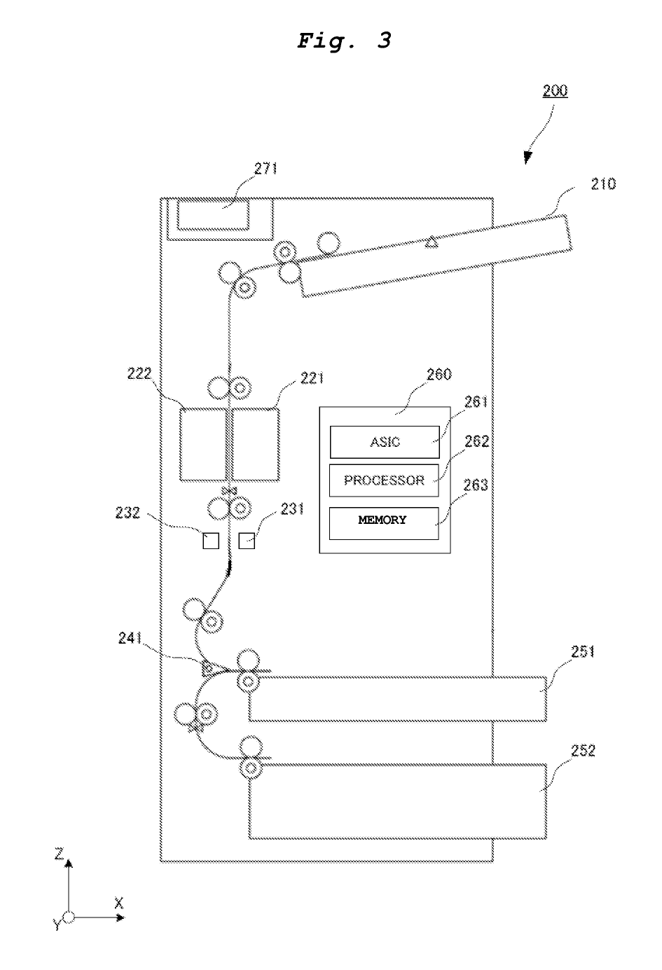

Next, the erasing device of the embodiment will be explained with reference to FIG. 3.

An erasing device 200 is provided with a sheet feed tray 210, eraser units 221 and 222, detection units 231 and 232, a branch member 241, a destruction tray 251, a reutilization tray 252, a control unit 260, and an operation unit 271.

Sheets for reutilization are loaded into the sheet feed tray 210. Sheets with various sizes such as A4, A3, and B5 can be loaded into the sheet feed tray 210. The sheets that are loaded into the sheet supply tray 210, for example, are sheets on which images have been formed by the image forming device 100.

The eraser units 221 and 222 erase colors of images of sheets that are conveyed. For example, the eraser units 221 and 222 heat a sheet up to a certain erasing temperature in a state in which the eraser units 221 and 222 make contact with the sheet that is conveyed, so that colors of an image formed on the sheet are erased. The eraser unit 221 is a unit for the first surface erasing process of the sheets and the eraser unit 222 is a unit for second surface erasing. The erasing units 221 and 222, respectively, have a heater lamp for generating heat by the supply of power and are oppositely arranged via a conveyance path. The eraser unit 221 makes contact with the sheet and heats one surface of the sheet. The eraser unit 222 makes contact with the sheet and heats the other surface of the sheet. In other words, the images of both surfaces of the sheet that is conveyed are erased by one conveyance.

Downstream from the eraser units 221 and 222, there are detection units 231 and 232. The detection units 231 and 232 are units for detecting the existence of patches shown in FIG. 2 and are fixed to patch-passage positions. The detection unit 231 is a unit for the first surface detection of sheets, and the detection unit 232 is a unit for the second surface detection. With the detection units 231 and 232, the existence of patches of both surfaces of a sheet that is conveyed is detected by one conveyance.

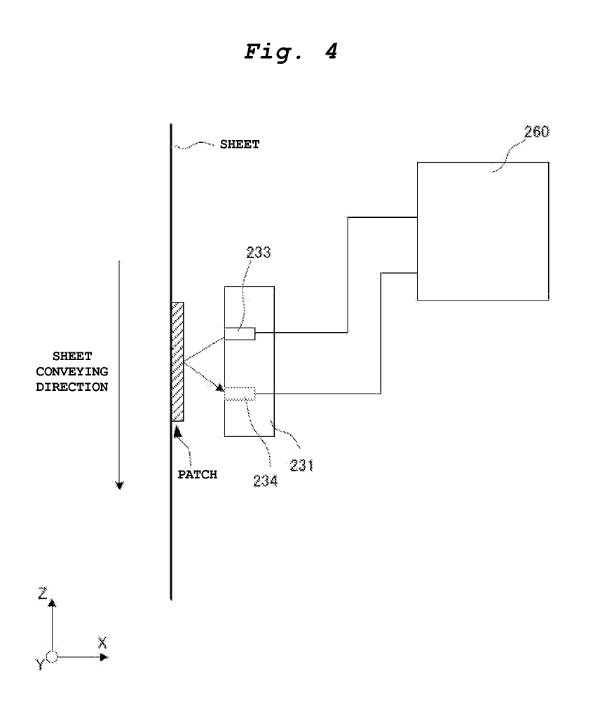

A detailed constitution of the detection units 231 and 232 will be explained with reference to FIG. 4. In FIG. 4, the detection unit 231 is shown; however, the detection unit 232 has a similar constitution. The detection unit 231 includes a light emitting element 233 and a light receiving element 234. The light emitting element 233 emits light in accordance with a light-emission timing signal from the control unit 260. The light-emission timing signal is output at the passage time of the patch positions. It is assumed that the passage of the patch positions at a certain time is predetermined based on, e.g., the conveyance speed of the sheet and the size of the sheet. The light emitting element 233 irradiates a patch position and the light receiving element 234 receives its reflected light. The quantity of light (voltage level) received by the light receiving element 234 is output as a detection signal to the control unit 260. If the patch position is a white color or a color close to white, the quantity of reflected light is increased, raising the voltage level that is output. On the other hand, if the erasure is poor and a patch remains, the quantity of reflected light is decreased and the voltage level is lowered.

In FIG. 3, the branch member 241 is downstream from the detection units 231 and 232. The branch member 241 switches the conveying direction in accordance with a control signal from the control unit 260 so that the conveyance destination of the sheets may be the destruction tray 251 or the reutilization tray 252.

The destruction tray 251 is a tray into which sheets that are determined to be non-reusable sheets are loaded. The reutilization tray 252 is a tray into which sheets that are determined to be reusable sheets are loaded.

The control unit 260 is a unit for overall controlling each hardware component and/or software module of the erasing device 200 and has an ASIC 261, a processor 262, and a memory 263. The control unit 260 outputs a light-emission timing signal to the detection units 231 and 232 and inputs detection signals from the detection units 231 and 232. The control unit 260 performs an A/D conversion on the input detection signals. If the signal level is lower than a certain level, it is decided that a non-erased image remains. If the signal level is the designated level or higher, it is decided that no non-erased image remains. The control unit 260 outputs a control signal to the branch member 241 according to this decision.

The operation unit 271 disposed in the upper part of the main body of the erasing device 200 has a touch panel input unit and display unit, as well as various kinds of operation keys. For the operation keys, for example, there are function keys, a numeric keypad, and the like. A user instructs the functional operation of the erasing device 200, such as the start of erasing processing or the reading of the image of a sheet to be erased, via the operation unit 271. The operation unit 271 receives setup information of the erasing device 200 and displays a message to the user.

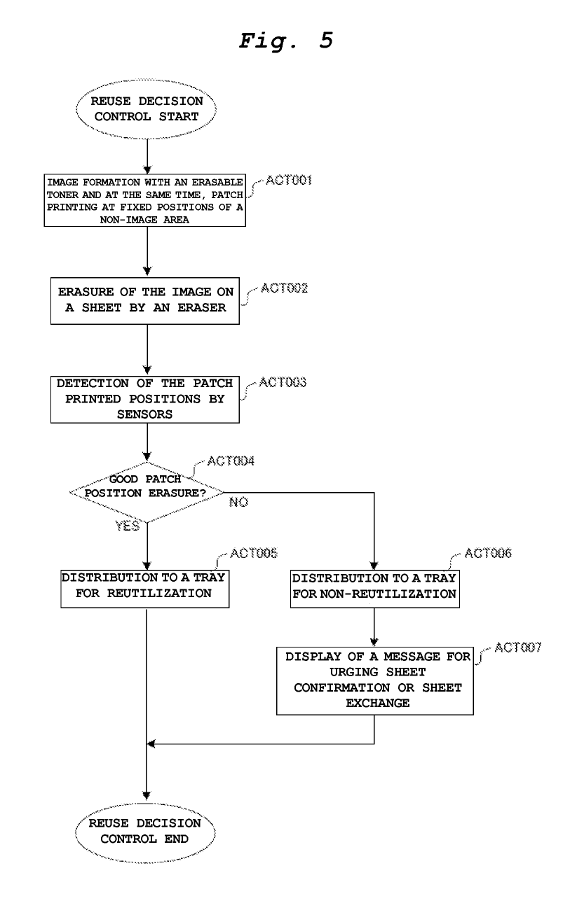

FIG. 5 is a flow chart showing an operation example of this embodiment. First, the image forming device 100 forms the desired image by an erasable toner and prints patches at fixed positions of the blank part of a non-image area at the same time (ACT001).

If a sheet printed by the image forming device 100 is used, it is loaded into the sheet feed tray 210 of the erasing device 200.

Based on instructions from the operation part 271, the erasing device 200 conveys the sheet that was loaded into the sheet feed tray 210 to the main body and erases the images with the eraser units 221 and 222 (ACT002). After the treatment in the eraser units 221 and 222, the detection units 231 and 232 emit light to the patch printed positions of the sheet and receive its reflected light, detecting the residual image existence of the patches (ACT003). These detection signals are output to the control unit 260, and then the control unit 260 decides whether or not the erasing is good based on the detected signals (ACT004). This decision, as mentioned above, is made according to whether or not the level of the detected signals is a designated level or higher. The designated level is stored in advance in the memory 263.

If the level is the designated level or higher, that is, if the erasure treatment is good (ACT004, YES), the control unit 260 switches the branch member 241 so that the sheet is conveyed to the reutilization tray 252 (ACT005). The sheet is conveyed to the reutilization tray 252 as guided by the branch member 241.

On the other hand, if the level is lower than the designated value, that is, if the erasure treatment is poor (ACT04, NO), the control unit 260 switches to the branch member 241 so that the sheet is conveyed to the destruction tray 251 (ACT006). The sheet is conveyed to the destruction tray 251 as guided by the branch member 241. The operation unit 271 displays a message for urging sheet confirmation or sheet exchange (ACT007). Here, the control unit 260 inputs the detection signals from both detection units 231 and 232. If it is decided from any of these signals that the erasing is poor, the control unit 260 switches the branch member 241 so that the sheet is conveyed to the destruction tray 251.

If several sheets are loaded into the sheet feed tray 210, the processes of the ACT002-ACT007 are carried out for each sheet. In addition, the sheets loaded into the reutilization tray 252 are housed in a feed cassette of the image forming device 100 or loaded into the feed tray, then erasable images are formed again on the sheets. At the time of this erasable image re-formation, patches are also provided at the same positions.

The image formation part P of this embodiment renders patches to predetermined fixed positions. Therefore, since the patches are rendered to the same positions each time, the detection at the erasing device 200 is made easy. In addition, in printing on an area where the desired printing image of a user is printed (hereinafter, ordinary printing area), since the content of each printing is different, sometimes the image is formed or is not formed in arbitrary areas of the ordinary printing area. On the other hand, if the patch positions are fixed, the area is printed each time it is used. Therefore, even if the erasing treatment is applied, the erased patch positions will deteriorate before the ordinary printing area. The patch position—where the erasing is poor—is taken as the basis of the decision on the reutilization of the sheet. Thus a situation can be avoided in which a residual image exists in the ordinary printing area in actuality, even if a good decision is made based on detection in an area other than the predetermined patch position.

Moreover, the image formation part P forms the patches at a coating density of the maximum pixel value (i.e., the maximum toner density) or greater than the coating amount of the toner when printing is carried out in the ordinary printing area. When a toner image is formed on a sheet, the image forming device 100 can detect the coating amount of the toner for each pixel. The image formation part P extracts a pixel in which the coating amount of the toner is largest and forms a patch so that the coating amount is the coating amount of the toner or more than this. Therefore, the patch has the desired image density or higher. Since the patch is as at least as dense as the densest portion of the image, even if the erasing treatment is applied, the image is apt to remain. This position is assumed as the basis of the decision, thereby a situation can be avoided in which a residual image exists in the ordinary printing area in actuality, even if a good decision is made based on a determination of a less toner-dense area.

In the example, the detection units 231 and 232 are present in the erasing device 200, and the detection units 231 and 232 are arranged downstream from the erasing parts 221 and 222. However, this embodiment is not limited to this arrangement. The detection function of the detection units of this embodiment may be implemented before a sheet is printed, after the sheet is erased. In consideration of this concept, the detection units may also be mounted in the image forming device.

In the image forming device 100 of FIG. 1, an arrangement can also be made use of in the image forming device 100 in which a sheet after a erasing treatment is housed in a feed cassette and loaded into a feed tray, and in which the sheet is formed again as a reusable sheet. In this case, the detection parts may be mounted from the position where the reusable sheet is fed (the position of the pickup rollers 51) to the position T where an image is transferred to the sheet (for example, the position of Po1). With the detection process at this position, the control unit 800 can discharge the reusable sheet determined to have poor erasure as it is, without any printing and can form an image on the reusable sheet determined to have good erasure.

In addition, there is an image forming device that can also carry out a erasing treatment. In this image forming device, through switching to the erasing mode, an image can be erased by heating a fixing device to the erasing temperature or higher. The erasing temperature may be higher than a fixing temperature. For example, in the image forming device 100, the fixer 7 can be heated to the erasing temperature or higher by mode switching. In the erasing mode, a used sheet, on which an image has been formed by an erasable toner, is fed from the pickup rollers 51 and conveyed to the fixer 7. The fixer 7 carries out a treatment for erasing the image by heating the sheet to a high temperature. With the arrangement of the detection units 231 and 232 downstream (for example, the position of Po2) of the fixer 7 of the image forming device 100, the control unit 800 can decide whether or not the erasure has been appropriately carried out by a similar method. In the image forming device 100 of FIG. 1, there is one tray for discharge, but several trays may similarly be arranged. Thus the discharge destination of a sheet can be switched depending on good/poor erasing. Moreover, if there is only one tray for discharge, it may also be mounted for discharge so that a step difference is generated in sheets depending on good/poor erasing (e.g., so that a difference is generated in the Y-axis direction). Furthermore, a message showing “the n-th sheet has poor erasure” may also be displayed on the control panel 810.

In addition, the detection parts of this embodiment may be mounted in the automatic document feeder. In FIG. 1, the detection units 231 and 232 are arranged in the automatic document feeder 9, for example, at the position of Po3. A user loads an erased sheet into a tray Rt and starts to implement the process in a designated mode, feeding the sheet to the main body part of the automatic document feeder 9. The detection units 231 and 232 carry out the detection process, so that the control unit 800 can determine whether or not the erasing has been appropriately carried out by the similar method. In case there is one tray for discharge, the sheet may be discharged with a step difference, or a message for notifying the sheet number with poor erasing can be displayed.

In this embodiment, when an image is formed by an erasable toner, patches are printed in designated areas (areas such as the header and footer) other than the image formation area, and in the areas in which the patches of a sheet after erasing are detected by the density sensors (detection units 231 and 232 of the example). In this manner, whether or not the erasing has been able to be properly applied by the erasing device can be decided from the outputs of the density sensors, so that even without mounting a scanner, whether or not the sheet can be reused can be decided using density sensors having a simple structure.

With this arrangement, sheets printed with the erasable toner are passed through the erasing device and subjected to a reutilization decision using the density sensors. Reusable sheets are distributed to one tray and non-reusable sheets are distributed to another tray. Further, a message for urging sheet confirmation or sheet exchange can be displayed.

In a copy process, an image acquisition unit corresponds to the read part R of this embodiment. However, in a printing process, it may be a network unit connected via a wired or wireless connection to an external device (for example, a computer) used as a transmission source of image data to be printed.

In addition, an erasure decision device includes the detection unit 231 (and/or detection unit 232) and the control unit 260 shown in FIG. 4 in this embodiment.

Moreover, in the explanation of this embodiment, by using an erasable toner, images are erased by applying heat at a fixed erasing temperature, but any variation may be applied as long as images are erased. Furthermore, the erasing device is one that carries out image processing for erasing images that are formed on sheets and the image forming device is one that carries out image processing for forming images on sheets. Either of these devices can be called an image processing device.

As explained above in detail, according to the technique described in this specification, whether or not an erasing process has been appropriately applied to sheets printed with an erasable toner can be determined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An erasure decision device, comprising:
a detection unit configured to detect at least one mark at a predetermined position on a sheet after an erasing treatment and to output the detection result; and
a control unit configured to determine whether a residual image remains on the sheet after the erasing treatment based on the detection result.

2. The erasure decision device according to claim 1, wherein the detection unit comprises:
alight emitting element configured to emit light to the predetermined positions on the sheet, and
a light receiving element configured to receive reflected light that is the emitted light reflected from the predetermined positions.

3. The erasure decision device according to claim 1, wherein
the detection unit is disposed in an image forming device, and arranged downstream in a sheet-conveying direction from pickup rollers configured to feed the sheet, and arranged upstream from a position in which an image is formed on the sheet.

4. The erasure decision device according to claim 1, wherein
the detection unit is disposed in a conveying device configured to convey the sheet to a designated place in an image forming device.

5. The erasure decision device according to claim 1, wherein
the control unit is further configured to control conveyance of the sheet between at least two conveyance paths based on the result of the determination.

6. The erasure decision device according to claim 5, wherein the at least two conveyance paths comprise a reuse path, in which a sheet is conveyed to a reuse tray for reuse, and a destruction path, in which a sheet is conveyed to a destruction tray for being discarded.

7. The erasure decision device according to claim 1, wherein
the control unit is configured to provided a message for display on a display part if the control unit determines that a residual image exists on the sheet.

8. An image processing device, comprising:
an erasure unit configured to erase images formed on a sheet;
a detection unit configured to detect at least one mark at a predetermined position on a sheet after an erasing treatment and to output the detection result; and
a control unit configured to determine whether a residual image remains on the sheet after the erasing treatment based on the detection result.

9. The image processing device according to claim 8, wherein the detection unit comprises:
a light emitting element configured to emit light to the predetermined positions on the sheet, and
a light receiving element configured to receive reflected light that is the emitted light reflected from the predetermined positions.

10. The image processing device according to claim 8, wherein
the detection unit is disposed in an image forming device, and arranged downstream in a sheet-conveying direction from pickup rollers configured to feed the sheet, and arranged upstream from a position in which an image is formed on the sheet.

11. The image processing device according to claim 8, wherein
the detection unit is disposed in a conveying device configured to convey the sheet to a designated place in an image forming device.

12. The image processing device according to claim 8, wherein
the control unit is further configured to control conveyance of the sheet between at least two conveyance paths based on the result of the determination.

13. The image processing device according to claim 12, wherein the at least two conveyance paths comprise a reuse path, in which a sheet is conveyed to a reuse tray for reuse, and a destruction path, in which a sheet is conveyed to a destruction tray for being discarded.

14. The image processing device according to claim 8, wherein
the control unit is configured to provided a message for display on a display part if the control unit determines that a residual image exists on the sheet.

15. An image forming device, comprising:
an image acquisition unit configured to acquire an image to be printed; and
an image formation unit configured to form the image to be printed by an erasable colorant on a recording medium, and to form at least one mark by the erasable colorant at a predetermined area on the recording medium other than an area where the image is formed by the erasable colorant.

16. The image forming device according to claim 15, wherein
the image to be printed is comprised of pixels, each to be printed with a respective image colorant density onto the recording medium, and
the image formation unit is configured to form the at least one mark with a mark colorant density amount equal to or greater than a greatest image colorant density from among the respective image colorant densities.

17. The image forming device according to claim 15, wherein the image acquisition unit determines the greatest image colorant density from among the respective image colorant densities of the pixels that comprise the image to be printed.

18. The image forming device according to claim 15, wherein the predetermined area is in a header area.

19. The image forming device according to claim 15, wherein the predetermined area is in a footer area.

20. The image forming device according to claim 15, wherein predetermined area is an area where a mark has been previously formed and erased.
